(19) United States
(12) Patent Application Publication
(10) Pub. No.: US 2026/0155352 A1
(43) Pub. Date: Jun. 4, 2026

(54) METHOD FOR MANUFACTURING POSITIVE ELECTRODE FOR ALL-SOLID-STATE BATTERY, POSITIVE ELECTRODE FOR ALL SOLID-SOLID BATTERY, AND ALL-SOLID-STATE BATTERY

(71) Applicant: SAMSUNG SDI CO., LTD., Yongin-si (KR)

(72) Inventors: Hanseul KIM, Yongin-si (KR); Seonhyeok AN, Yongin-si (KR); Dongsu KIM, Yongin-si (KR)

(73) Assignee: SAMSUNG SDI CO., LTD., Yongin-si (KR)

(21) Appl. No.: 19/401,723

(22) Filed: Nov. 26, 2025

(30) Foreign Application Priority Data
Nov. 29, 2024 (KR) 10-2024-0175409

(51) Int. Cl. H01M 4/139; H01M 4/02; H01M 4/36; H01M 10/0525; H01M 10/0562; H01M 10/058

(52) U.S. Cl. CPC H01M 4/139; H01M 4/366; H01M 10/0525; H01M 10/0562; H01M 10/058; H01M 2004/021; H01M 2004/028

(57) ABSTRACT

The present invention relates to a method for manufacturing a positive electrode for an all-solid-state battery, a positive electrode for the all-solid-state battery, and an all-solid-state battery including the positive electrode. The method for manufacturing the positive electrode all-solid-state battery includes forming a unit active material layer through a dry process, the unit active material layer including a first layer containing a first positive active material and a first solid electrolyte, and a second layer containing a second positive active material and a second solid electrolyte; forming a stack in which the first and second layers are alternately arranged in a first direction; slicing the stack in a second direction crossing the first direction to form a positive active material layer; and laminating the positive active material layer on a positive current collector such that the first and second layers are in contact with the positive current collector.

### CROSS-REFERENCE TO RELATED APPLICATION

This U.S. nonprovisional application claims priority under 35 U.S.C § 119 to Korean Patent Application No. 10-2024-0175409 filed on Nov. 29, 2024, in the Korean Intellectual Property Office, the disclosure of which is hereby incorporated by reference in its entirety.

### BACKGROUND

The present disclosure relates to a method for manufacturing a positive electrode for an all-solid-state battery, a positive electrode for the all-solid-state battery manufactured using the method, and an all-solid-state battery including the positive electrode.

Due to increasing demand, the development of batteries with high energy density and safety is being actively conducted. For example, lithium-ion batteries are used not only in the information-related devices and communication devices fields, but also in, e.g., the automobile field. In the automobile field, safety is relevant because safety is directly related to preserving human life.

An all-solid-state battery in which an electrolyte solution is replaced with a solid electrolyte has been proposed. The all-solid-state battery may substantially reduce the possibility of fire or explosion even when a short circuit occurs, as the all-solid-state battery does not use flammable organic dispersion medium. Therefore, such an all-solid-state battery may have significantly higher safety than a lithium-ion battery using an electrolytic solution.

### SUMMARY

The present disclosure describes a method for manufacturing a positive electrode for an all-solid-state battery having both improved electron conductivity and ion conductivity.

The present disclosure also describes a positive electrode for an all-solid-state battery having both improved electron conductivity and ion conductivity.

The present disclosure also describes an all-solid-state battery having high capacity and high output characteristics.

In an example embodiment of the present disclosure, a method for manufacturing a positive electrode for an all-solid-state battery may include forming a unit active material layer through a dry process, the unit active material layer including a first layer containing a first positive electrode active material and a first solid electrolyte, and a second layer containing a second positive electrode active material and a second solid electrolyte, the second layer being on the first layer; forming a stack in which the first and second layers are alternately arranged in a first direction; slicing the stack in a second direction crossing the first direction to form a positive electrode active material layer, the slicing of the stack including cutting the first and second layers together; and laminating the positive electrode active material layer on a positive electrode current collector such that the first and second layers may be in contact with the positive electrode current collector.

In an example embodiment of the present disclosure, a positive electrode for an all-solid-state battery may include a positive electrode current collector, and a positive electrode active material layer on the positive electrode current collector. The positive electrode active material layer may include a first layer containing a first positive electrode active material and a first solid electrolyte, and a second layer containing a second positive electrode active material and a second solid electrolyte. The second layer is in contact with the first layer, and the first layer and the second layer may be disposed side-by-side on the positive electrode collector.

In an example embodiment of the present disclosure, an all-solid-state battery may include a positive electrode layer, a negative electrode layer, and a solid electrolyte layer between the positive electrode layer and the negative electrode layer. The positive electrode layer may include a positive electrode current collector, and a positive electrode active material layer on the positive electrode current collector, the positive electrode active material layer may include a first layer containing a first positive electrode active material and a first solid electrolyte, and a second layer containing a second positive electrode active material and a second solid electrolyte. The second layer is in contact with the first layer, and the first layer and the second layer may be disposed side-by-side on the positive electrode collector.

### BRIEF DESCRIPTION OF DRAWINGS

FIG. 1 is a cross-sectional view of an all-solid-state battery according to an example embodiment of the present disclosure.

FIG. 2 is an enlarged view of the region designated as “M” in FIG. 1.

FIG. 3 is a cross-sectional view of an all-solid-state battery according to another example embodiment of the present disclosure.

FIG. 4 is a cross-sectional view of an all-solid-state battery according to another example embodiment of the present disclosure.

FIG. 5 is a cross-sectional view of an all-solid-state battery according to another example embodiment of the present disclosure.

FIG. 6 is a cross-sectional view of an all-solid-state battery according to a comparative example of the present disclosure.

FIG. 7 is an enlarged view of the region designated as “N” in FIG. 6.

FIG. 8 to FIG. 11 are perspective views describing a method for manufacturing a positive electrode for an all-solid-state battery, according to an example embodiment of the present disclosure.

FIG. 12 and FIG. 13 are perspective views describing a method for manufacturing a positive electrode for an all-solid-state battery, according to another example embodiment of the present disclosure.

FIG. 14 and FIG. 15 are perspective views describing a method for manufacturing a positive electrode for an all-solid-state battery according to another example embodiment of the present disclosure.

FIG. 16 is a flow chart illustrating a method for manufacturing a positive electrode for an all-solid-state battery, according to various example embodiments.

### DETAILED DESCRIPTION OF EMBODIMENTS

In order to sufficiently understand the configuration and effects of the present disclosure, example embodiments of the present disclosure are described with reference to the accompanying drawings. However, the present disclosure is not limited to the example embodiments disclosed below, and may be implemented in various forms and modified in various forms. Rather, these example embodiments are provided so that this disclosure is thorough and complete, and fully conveys the scope of the present disclosure to those skilled in the art to which the present disclosure pertains.

In this specification, it is understood that, when an element is referred to as being “on” another element, the element may be “directly on” the other element, or intervening elements may be present therebetween. In the drawings, thicknesses of components may be exaggerated for effectively explaining the technical contents. Like reference numerals or symbols refer to like elements throughout the specification.

Example embodiments described herein are explained with reference to cross-sectional views and/or plan views, which are ideal illustrations of the present disclosure. In the drawings, thicknesses of films and regions may be exaggerated for effectively explaining the technical contents. Accordingly, the regions illustrated in the drawings have schematic properties, and the shapes of the regions illustrated in the drawings are intended to illustrate a specific shape of the regions of an element, and are not intended to limit the scope of the disclosure. In various example embodiments of the present specification, terms such as first, second, and third are used to describe various components, but these components should not be limited by these terms. These terms are merely used to distinguish one component from another. Example embodiments described and illustrated herein also include complementary embodiments thereof.

The terminology used herein is for describing example embodiments, and is not intended to limit the present disclosure. In this specification, the singular forms are intended to include the plural forms as well, unless the context clearly indicates otherwise. The terms “comprises/includes” and/or “comprising/including” used in this specification do not exclude the presence or addition of one or more other components.

In this specification, “combination thereof” may refer to a mixture, a stack, a composite, a copolymer, an alloy, a blend, and a reaction product of components.

Unless otherwise defined herein, a particle diameter may be an average particle diameter. Also, the particle diameter may refer to an average particle diameter (D50) which means a diameter of particles at a cumulative volume of about 50 vol % in a particle size distribution. The average particle diameter (D50) may be measured by a method known to those skilled in the art, for example, may be measured by a particle size analyzer, or may also be measured using a transmission electron microscope (TEM) image or a scanning electron microscope (SEM) image. Alternatively, the average particle diameter may be measured by a measuring device using dynamic light-scattering, wherein the number of particles is counted for each particle size range by performing data analysis, and an average particle diameter (D50) value may then be obtained by calculation therefrom. Also, the average particle diameter may be measured using a laser diffraction method. When measured by the laser diffraction method, for example, after dispersing particles to be measured in a dispersion medium, the dispersion medium is introduced into a commercial laser diffraction particle size measurement instrument (e.g., Microtrac MT 3000) and irradiated with ultrasonic waves of about 28 kHz at an output of about 60 W, and the average particle diameter (D50) based on about 50% of particle size distribution in the measurement instrument may then be calculated.

In this specification, each of phrases such as “A or B,” “at least one of A and B,”, “at least one of A or B,” “A, B, or C,” “at least one of A, B, and C,” and “at least one of A, B, or C” may include any one of the items listed with the respective phrase, or any possible combination thereof.

In this specification, “dry” or “dry process” may refer to a state in which a solvent, such as a process solvent, may not be intentionally contacted or a state in which the solvent may not be intentionally contained. For example, a dry binder may refer to a binder that may not be intentionally in contact with a solvent, or a binder that may not intentionally include a solvent. For example, a binder in a liquid state at room temperature without being mixed with a solvent may be a dry binder.

In this specification, “dry electrode” or “dry electrode film” may refer to an electrode or electrode film that may not contain a solvent or may not intentionally use a solvent in the course of electrode preparation. Solvents may include process solvents, process solvent residues, process solvent impurities, and the like.

In this specification, “free-standing film” may include a binder matrix structure, and the electrode film or electrode layer may be free-standing or self-supporting by being supported by the binder matrix structure. The free-standing electrode film or the free-standing electrode active material layer by be used in the manufacture of a rechargeable lithium battery without a support such as a current collector by including a binder matrix structure. The free-standing electrode film or the free-standing electrode active material layer may have sufficient film strength or layer strength to be rolled, handled, and/or unrolled without other supports, for example.

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

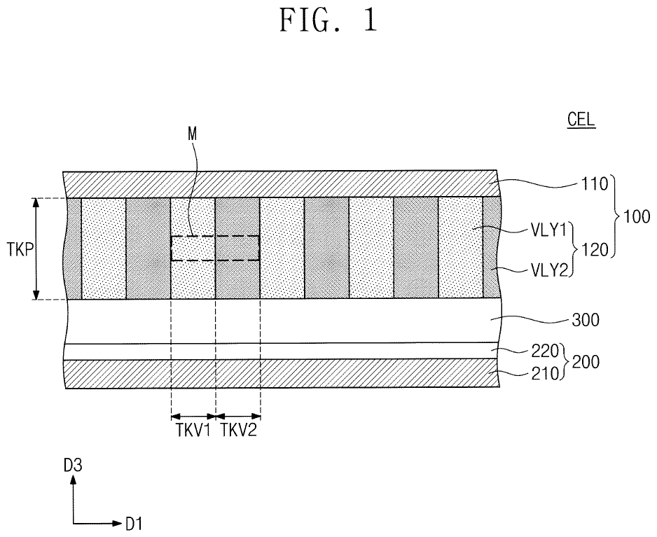

FIG. 1 is a cross-sectional view of an all-solid-state battery, according to an example embodiment of the present disclosure.

Referring to FIG. 1, a unit cell (CEL) of an all-solid-state battery according to the present disclosure may include a positive electrode layer 100, a negative electrode layer 200 opposing the positive electrode layer 100, and a solid electrolyte layer 300 disposed between the positive electrode layer 100 and the negative electrode layer 200. However, the present disclosure may not be limited thereto, and the unit cell CEL may further include at least an additional functional layer, for example, an adhesion improvement layer, disposed between the positive electrode layer 100 and the solid electrolyte layer 300, or between the negative electrode layer 200 and the solid electrolyte layer 300.

The positive electrode layer 100 according to an example embodiment of the present disclosure may include a positive electrode current collector 110 and a positive electrode active material layer 120 disposed on the positive electrode current collector 110. The positive electrode active material layer 120 may include at least one of a positive electrode active material, a solid electrolyte, a conductive material, and a binder.

The positive electrode current collector 110 may provide a reference surface on which the positive electrode active material layer 120 may be disposed. The positive electrode current collector 110 may include, for example, a plate or foil including at least one of indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof.

On the other hand, unlike the configuration illustrated in FIG. 1, the positive electrode current collector 110 may be omitted in one example embodiment of the present disclosure. Although not shown, a carbon layer having a thickness in a range of about 0.1 μm to about 4 μm may be further disposed between the positive electrode current collector 110 and the positive electrode active material layer 120 in order to increase the binding force between the positive electrode collector 110 and the positive electrode active material layer 120.

The positive electrode active material of the positive electrode active material layer 120 may include a material capable of reversibly absorbing and desorbing lithium ions. The positive electrode active material may include a plurality of particles. The positive electrode active material may include, for example, lithium transition metal oxides such as or including at least one of lithium cobalt oxide (LCO), lithium nickel oxide, lithium nickel cobalt oxide, lithium nickel cobalt aluminum oxide (NCA), lithium nickel cobalt manganese oxide (NCM), lithium manganate, and lithium iron phosphate, nickel sulfide, copper sulfide, lithium sulfide, iron oxide, or vanadium oxide, but is not necessarily limited thereto. The positive electrode active materials may be used alone, or may be a mixture of two or more thereof.

The lithium transition metal oxide may be or include, for example, a compound represented by any one of LiₐA_{1-b}B_{b}D₂ (0.90≤a≤1, 0≤b≤0.5), LiₐE_{1-b}B_{b}O_{2-c}D_{c} (0.90≤a≤1, 0≤b≤0.5, 0≤c≤0.05), LiE_{2-b}B_{b}O_{4-c}D_{c} (0≤b≤0.5, 0≤c≤0.05), LiₐNi_{1-b-c}Co_{b}B_{c}D_{α} (0.90≤a≤1, 0≤b≤0.5, 0≤c≤0.05, 0<α<2), LiₐNi_{1-b-c}Co_{b}B_{c}O_{2-α}F_{α} (0.90≤a≤1, 0≤b≤0.5, 0≤c≤0.05, 0<α<2). LiₐNi_{1-b-c}Mn_{b}B_{c}D_{α} (0.90≤a≤, 0≤b≤0.5, 0≤c≤0.05. 0<α≤2), LiₐNi_{1-b-c}Mn_{b}B_{C}O_{2-α}F_{α} (0.90≤a≤1, 0≤b≤0.5, 0≤c≤0.05, 0<α<2), LiₐNi_{b}E_{c}G_{d}O₂ (0.90≤a≤1, 0≤b≤0.9, 0≤c≤0.5, 0.001≤d≤0.1), LiₐNi_{b}Co_{c}Mn_{d}GeO₂ (0.90≤a≤1, 0≤b≤0.9, 0≤c≤0.5, 0≤d≤0.5, 0.001≤e≤0.1), LiₐNiG_{b}O₂ (0.9≤a≤1, 0.001≤b≤0.1), LiₐCoG_{b}O₂ (0.90≤a≤1, 0.001≤b≤0.1), LiₐMnG_{b}O₂ (0.90≤a≤1, 0.001≤b≤0.1), LiₐMn₂GbO₄ (0.90≤a≤1, 0.001≤b≤0.1), QO₂, QS₂, LiQS₂, V₂O₅, LiV₂O₅, LiIO₂, LiNiVO₄, Li_{3-f}J₂(PO₄)₃ (0≤f≤2), Li_{3-f}Fe₂(PO₄)₃ (0≤f≤2), and LiFePO₄. In such compounds, the capital letter “A” is or includes at least one of Ni, Co, Mn, or a combination thereof, the capital letter “B” is or includes at least one of Al, Ni, Co, Mn, Cr, Fe, Mg, Sr, V, a rare earth element, or a combination thereof, the capital letter “D” is or includes at least one of O, F, S, P, or a combination thereof, the capital letter “E” is or includes at least one of Co, Mn or a combination thereof, the capital letter “F” is or includes at least one of F, S, P, or a combination thereof, the capital letter “G” is or includes at least one of Al, Cr, Mn, Fe, Mg, La, Ce, Sr, V, or a combination thereof, the capital letter “Q” is or includes at least one of Ti, Mo, Mn, or a combination thereof, the capital letters “I” is or includes at least one of Cr, V, Fe, Sc, Y, or a combination thereof, and the capital letter “J” is or includes at least one of V, Cr, Mn, Co, Ni, Cu, or a combination thereof.

The positive electrode active material may include, for example, a lithium salt of a transition metal oxide having a layered rock salt type structure among the above-described lithium transition metal oxides. The “layered rock salt type structure” is, for example, a structure in which oxygen atom layers and metal atom layers are alternatively and regularly arranged in the <111> direction of a cubic rock salt type structure, whereby each atomic layer forms a two-dimensional plane. The “cubic rock salt type structure” refers to a sodium chloride type (NaCl type) structure, which is a type of crystal structure, and for example refers to a structure in which face centered cubic lattices (fcc) formed by each of cations and anions are misaligned by half (½) the ridge of a unit lattice. The lithium transition metal oxide having such a layered rock salt structure may be or include, for example, a ternary lithium transition metal oxide such as LiNiₓCo_{y}Al_{z}O₂ (NCA) or LiNiₓCo_{y}Mn_{z}O₂ (NCM) (0<x<1, 0<y<1, 0<z<1, x+y+z=1). When the positive electrode active material includes a ternary lithium transition metal oxide having the layered rock salt type structure, the energy density of the unit cell (CEL) may increase and the thermal stability may be improved.

The above-described compound included in the positive electrode active material may be covered by a coating layer (not shown). The positive electrode active material may also be a mixture of the above-described compound and a compound to which a coating layer is added. For example, the coating layer added to the surface of the positive electrode active material may include, at least one of an oxide, a hydroxide, an oxyhydroxide, an oxycarbonate, or a hydroxycarbonate of the following coating elements. The compound constituting or included in the coating layer may be amorphous or crystalline. The coating elements contained in the coating layer may include at least one of Mg, Al, Co, K, Na, Ca, Si, Ti, V, Sn, Ge, Ga, B, As, Zr, or a mixture thereof. The coating layer may include, for example, Li₂O—ZrO₂ (LZO) or the like. The method of forming the coating layer may be determined within a range that does not adversely affect the physical properties of the positive electrode active material. The method of forming the coating layer may include, for example, a spray coating method or an immersion method.

When the positive electrode active material is a ternary lithium transition metal oxide such as NCA or NCM and contains nickel (Ni), the capacity density of the unit cell CEL may be increased, thereby reducing metal elution of the positive electrode active material in a charged state. As a result, the cycle characteristic of the unit cell CEL in a charged state may be improved. For example, the “cycle characteristic” is a characteristic indicating the degree to which the unit cell CEL is deteriorated due to charging/discharging of the unit cell CEL. A unit cell CEL with a high cycle characteristic may have a small degree of deterioration due to charging/discharging, while a unit cell CEL having a low cycle characteristic may have a large degree of deterioration due to charge/discharge.

The positive electrode active material may have, for example, a particle shape such as a sphere or an ellipsoid. The particle diameter and the content of the positive electrode active material are not particularly limited.

The solid electrolyte of the positive electrode active material layer 120 may have a particle shape. The solid electrolyte may be dispersed between the positive electrode active materials. The solid electrolyte may include a sulfide-based solid electrolyte having desired or improved lithium-ion conductivity properties. The sulfide-based solid electrolyte may include, for example, at least one of Li₂S—P₂S₅, Li₂S—P₂S₅—LiX (X represents a halogen element), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n are positive numbers, and the capital letter “Z” represents any one of Ge, Zn, or Ga), Li₂S—GeS₂, Li₂S—SiS₂—Li₃PO₄, Li₂S—SiS₂-LiₚMO_{q} (p and q are positive numbers, and the capital letter “M” represents any one of P, Si, Ge, B, Al, Ga, or In), Li₇₋ₓPS₆₋ₓClₓ (0≤x≤2), Li₇₋ₓPS₆₋ₓBrₓ (0≤x≤2), and Li₇₋ₓPS₆₋ₓIₓ (0≤x≤2).

The sulfide-based solid electrolyte may be or include, for example, an Argyrodite-type compound including at least one of Li₇₋ₓPS₆₋ₓClₓ (0≤x≤2), Li₇₋ₓPS₆₋ₓBrₓ (0≤x≤2), and Li₇₋ₓPS₆₋ₓIₓ (0≤x≤2). For example, the sulfide-based solid electrolyte may be or include an Argyrodite-type compound including at least one of Li₆PS₅Cl, Li₆PS₅Br and Li₆PS₅I.

Alternatively, the sulfide-based solid electrolyte may be or include an Argyrodite-type compound including Li₇₋ₐMₐPS_{6-c}X_{c} (0≤a≤2, 0≤c≤2). Herein, X may be or include at least one of F, Br, Cl, I, or a combination thereof. M may be or include at least one of scandium (Sc), yttrium (Y), titanium (Ti), zirconium (Zr), hafnium (Hf), vanadium (V), niobium (Nb), tantalum (Ta), chromium (Cr), molybdenum (Mo), tungsten (W), manganese (Mn), technetium (Tc), rhenium (Re), iron (Fe), ruthenium (Ru), osmium (Os), cobalt (Co), rhodium (Rh), iridium (Ir), nickel (Ni), palladium (Pd), platinum (Pt), copper (Cu), silver (Ag), gold (Au), zinc (Zn), cadmium (Cd), mercury (Hg), aluminium (Al), gallium (Ga), indium (In), thallium (Tl), silicon (Si), germanium (Ge), tin (Sn), lead (Pb), arsenic (As), antimony (Sb), bismuth (Bi), or a combination thereof.

The density of the Argyrodite-type solid electrolyte may be in a range of about 1.5 g/cc to about 2.0 g/cc. Since the Argyrodite-type solid electrolyte has a density of about 1.5 g/cc or more, the internal resistance of the all-solid-state battery may be reduced, and a defect in which a solid electrolyte membrane is penetrated and short-circuited due to the formation of lithium dendrites may be reduced or prevented. The elastic modulus of the solid electrolyte may be, for example, in a range of about 15 GPa to about 35 GPa.

The solid electrolyte included in the positive electrode active material layer 120 may have a smaller average particle diameter than the solid electrolyte included in the solid electrolyte layer 300 described below. For example, the average particle diameter of the solid electrolyte in the positive electrode active material layer 120 may be in a range of about 90% or less, about 80% or less, about 70% or less, about 60% or less, about 50% or less, about 40% or less, about 30% or less, or about 20% or less of the average particle diameter of the solid electrolyte in the solid electrolyte layer 300. The average particle diameter may be a median diameter measured using, e.g., a laser type particle size distribution analyzer.

The positive electrode active material layer 120 may include a conductive material. The conductive material may exhibit conductivity without causing chemical change in the unit cell (CEL), thereby increasing the conductivity of the positive electrode active material and the solid electrolyte. The conductive material may include a carbon-based material. The conductive material may include, for example, at least one of graphite, carbon black, acetylene black, carbon nanofibers, and carbon nanotubes.

The positive electrode active material layer 120 may further include a binder. The binder may be configured to bind the positive electrode active material, the solid electrolyte, the conductive material, and the like, in the positive electrode active material layer 120 to each other. The binder may include a material to improve the bonding force between the positive electrode active material layer 120 and the positive electrode current collector 110. The binder may include, for example, at least one of polyvinylidenefluoride, styrene butadiene rubber (SBR), polytetrafluoroethylene, polyvinylidenfluoride, vinylidenefluoride/hexafluoropropylene copolymer, polyacrylonitrile, or polymethylmethacrylate.

The solid electrolyte layer 300 may be disposed between the positive electrode layer 100 and the negative electrode layer 200. The solid electrolyte layer 300 may include a sulfide-based solid electrolyte having desired or improved lithium-ion conductivity characteristics. The solid electrolyte in the solid electrolyte layer 300 may be the same as, or different from, any one of the materials included in the solid electrolyte in the positive electrode active material layer 120 described above.

The solid electrolyte may have a particle shape such as, e.g., a sphere or an ellipsoid. The solid electrolyte may include a sulfide-based solid electrolyte. The sulfide-based solid electrolyte may be formed by, for example, treating starting materials such as Li₂S and P₂S₅ by a melting quenching method, a mechanical milling method, or the like. In addition, after the treatment, a heat treatment may be performed. The solid electrolyte may be amorphous, crystalline, or a mixture thereof. In addition, the solid electrolyte may include, for example, at least sulfur (S), phosphorus (P), and lithium (Li) as constituent elements among the above-described sulfide-based solid electrolyte materials. For example, the solid electrolyte may be a material including Li₂S—P₂S₅. When the sulfide-based solid electrolyte material including Li₂S—P₂S₅ is used to form the solid electrolyte, the mixing molar ratio of Li₂S to P₂S₅ is, for example, in the range of Li₂S:P2S₅=50:50 to 90:10.

In an example embodiment, the solid electrolyte may include an Argyrodite-type compound including at least one of Li₇₋ₓPS₆₋ₓClₓ (0≤x≤2), Li₇₋ₓPS₆₋ₓBrₓ (0≤x≤2), and Li₇₋ₓPS₆₋ₓIₓ (0≤x≤2). The solid electrolyte may include an Argyrodite-type compound including at least one of Li₆PS₅Cl, Li₆PS₅Br and Li₆PS₅I.

In another example embodiment, the solid electrolyte may include an Argyrodite-type compound including Li₇₋ₐMₐPS_{6-c}X_{c}. Herein, X may be or include at least one of F, Cl, Br, or a combination thereof. M may be or include at least one of scandium (Sc), yttrium (Y), titanium (Ti), zirconium (Zr), hafnium (Hf), vanadium (V), niobium (Nb), tantalum (Ta), chromium (Cr), molybdenum (Mo), tungsten (W), manganese (Mn), technetium (Tc), rhenium (Re), iron (Fe), ruthenium (Ru), osmium (Os), cobalt (Co), rhodium (Rh), iridium (Ir), nickel (Ni), palladium (Pd), platinum (Pt), copper (Cu), silver (Ag), gold (Au), zinc (Zn), cadmium (Cd), mercury (Hg), aluminium (Al), gallium (Ga), indium (In), thallium (Tl), silicon (Si), germanium (Ge), tin (Sn), lead (Pb), arsenic (As), antimony (Sb), bismuth (Bi), or a combination thereof. M may be or include at least one of Na, K, Fe, Mg, Ca, Ag, Cu, Zr, Zn, or a combination thereof. Each of “a” and “c” may be a real number in a range between 0 and 2.

The density of the Argyrodite-type solid electrolyte may be in a range of about 1.5 g/cc to about 2.0 g/cc. Since the Argyrodite-type solid electrolyte has a density of about 1.5 g/cc or more, the internal resistance of the all-solid-state battery may be reduced, and a defect in which a solid electrolyte membrane is penetrated and short-circuited due to the formation of lithium dendrites may be reduced or prevented. The elastic modulus of the solid electrolyte may be in a range of, for example, about 15 GPa to about 35 GPa.

The solid electrolyte layer 300 may further include a binder. The binder included in the solid electrolyte layer 300 may include, for example, at least one of styrene-butadiene rubber (SBR), polytetrafluoroethylene, polyvinylidene fluoride, polyethylene, or the like, but may not be limited thereto. The binder of the solid electrolyte layer 300 may be the same as, or different from, the binder included in the positive electrode active material layer 120 or the binder included in the coating layer 220.

The cathode layer 200 may include a negative electrode current collector 210, and a coating layer 220 on the negative electrode current collector 210.

The negative electrode current collector 210 may provide a reference surface on which the coating layer 220 may be disposed. The negative electrode current collector 210 may include, for example, a material that does not react with lithium, that is, does not form an alloy or a compound with lithium. For example, the negative electrode current collector 210 may include at least one of copper (Cu), stainless steel, titanium (Ti), iron (Fe), cobalt (Co), nickel (Ni), aluminum (Al), silver (Ag), or an alloy thereof. The thickness of the negative electrode current collector 210 may be in a range of about 1 μm to about 20 μm, for example about 5 μm to about 15 μm, and for example about 7 μm to about 10 μm.

The negative electrode current collector 210 may be composed of or include one of the above-described metals, or may include an alloy or a cladding material of two or more metals. The negative electrode current collector 210 may have, for example, a plate shape or a foil shape. On the other hand, in an example embodiment, the negative electrode current collector 210 may be omitted.

The coating layer 220 may allow lithium metal to grow between the coating layer 220 and the negative electrode current collector 210 during charging of the unit cell CEL. The coating layer 220 may constitute a protective layer for lithium metal, and also reduce or suppress the precipitation and growth of lithium dendrites.

The coating layer 220 may include a metal and carbon. For example, the coating layer 220 may include at least one metal such as or including at least one of gold (Au), platinum (Pt), palladium (Pd), silicon (Si), silver (Ag), aluminium (Al), bismuth (Bi), tin (Sn), and zinc (Zn). The coating layer 220 may include at least one carbon such as or including at least one of carbon black, acetylene black, furnace black, ketjen black, and graphene. In an example embodiment, the coating layer 220 may include a mixture (or composite) of carbon black and silver (Ag).

The coating layer 220 may be thinner than the positive electrode active material layer 120. The thickness of the coating layer 220 may be, for example, in a range of about 50% or less, about 40% or less, about 30% or less, about 20% or less, about 10% or less, or about 5% or less of the thickness of the positive electrode active material layer 120. The thickness of the coating layer 220 may be, for example, in a range of about 1 μm to about 20 μm, about 2 μm to about 10 μm, or about 3 μm to about 7 μm. When the thickness of the coating layer 220 is low, e.g., less than about 1 μm, lithium dendrites formed between the coating layer 220 and the negative electrode current collector 210 may collapse the coating layer 220, thereby deteriorating the cycle characteristic of the unit cell CEL. When the thickness of the coating layer 220 increases substantially, e.g., greater than 20 μm, the energy density of the unit cell CEL may decrease, and the internal resistance of the unit cell CEL by the coating layer 220 may increase, so that the cycle characteristic of the unit cell CEL may decrease.

For example, although not shown, a carbon layer may be further included to improve adhesion between the coating layer 220 and the solid electrolyte layer 300.

Although not shown, as another example of the present disclosure, the areas of the positive electrode layer 100 and the negative electrode layer 200 in the unit cell CEL of the all-solid-state battery may be different from each other.

Alternatively, as another example of the present disclosure, the solid electrolyte layer 300 in the unit cell CEL of the all-solid-state battery may include a plurality of solid electrolyte layers. The areas of the plurality of solid electrolyte layers may be the same as, or different from, each other.

Alternatively, as another example of the present disclosure, the unit cell CEL of the all-solid-state battery may further include a gasket to fill a lateral step caused by the area difference.

Alternatively, as another example of the present disclosure, the unit cell CEL of the all-solid-state battery may further include a lithium metal layer between the negative electrode current collector 210 and the coating layer 220. The lithium metal layer may be formed, or the thickness thereof may be further increased during charging of the unit cell CEL.

Alternatively, as another example of the present invention, the unit cell CEL of the all-solid-state battery may be a bi-cell all-solid-state battery in which two different monocells are stacked together. The two different monocells may each include all of the configurations of the negative electrode layer 200, the solid electrolyte layer 300, and the positive electrode layer 100 described above. Two different monocells may be stacked such that the positive electrode current collectors are in contact with each other. The two different monocells may be arranged in a vertically symmetrical manner.

Hereinafter, the positive electrode layer 100 according to example embodiments of the present disclosure is described in more detail.

### Positive Electrode for All-Solid-State Battery

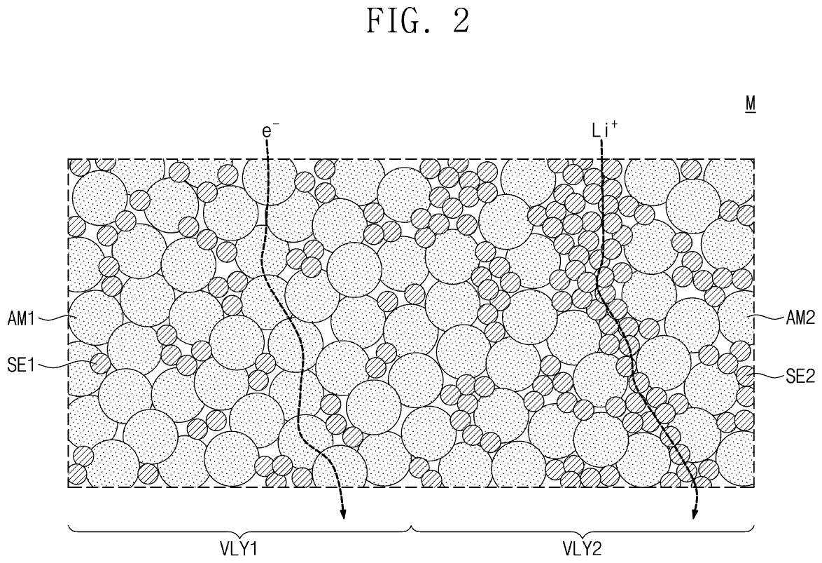

Referring to FIG. 1, the positive electrode active material layer 120 of the unit cell CEL of the all-solid-state battery according to examples of the present disclosure may include a first layer VLY1 and a second layer VLY2. The first layer VLY1 and the second layer VLY2 may each include a positive electrode active material, a solid electrolyte, a conductive material, and a binder. This is described in detail below with reference to FIG. 2.

Both the first layer VLY1 and the second layer VLY2 may be located on the positive electrode current collector 110. Both the first layer VLY1 and the second layer VLY2 may be in contact with the positive electrode current collector 110. Both the first layer VLY1 and the second layer VLY2 may be in contact with the solid electrolyte layer 300 of the unit cell CEL of the all-solid-state battery. The first layer VLY1 and the second layer VLY2 may be in contact with each other.

As an example, the first layer VLY1 may include a plurality of first layers. The second layer VLY2 may include a plurality of second layers. The plurality of first layers and the plurality of second layers may be alternately disposed in the horizontal direction (i.e., the first direction D1).

As an example, the width TKV1 of the first layer VLY1 in the first direction D1 may be substantially equal to the width TKV2 of the second layer VLY2 in the first direction D1. In this specification, a substantially equal width may be defined as the case where the difference between the two widths is within 10%. For example, the width TKV1 of the first layer VLY1 in the first direction D1 may be the same as the width TKV2 of the second layer VLY2 in the first direction D1.

The width of the first layer VLY1 in the third direction D3 may be substantially equal to the width of the second layer VLY2 in the third direction D3. For example, the width of the first layer VLY1 in the third direction D3 may be to the same as the width of the second layer VLY2 in the third direction D3. The width of the first layer VLY1 in the third direction D3 and the width of the second layer VLY2 in the third direction D3 may be the thickness TKP of the positive electrode active material layer 120.

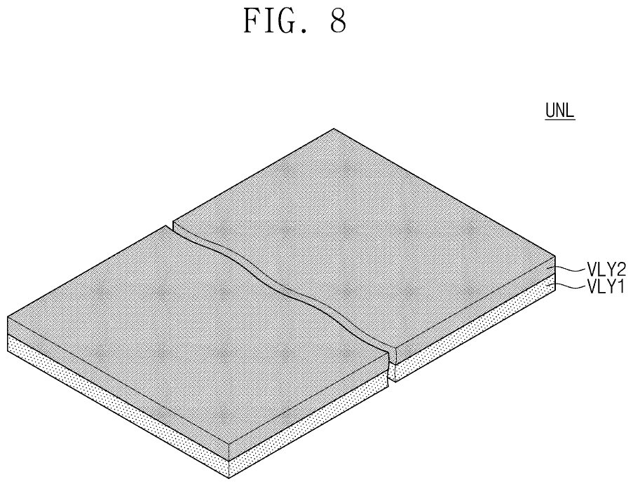

As is described below with reference to FIG. 8 to FIG. 11, the first layer VLY1 and the second layer VLY2 may be each formed through a dry process, and the first layer VLY1 and the second layer VLY2 may be bonded through a pressing process. After that, the first layer VLY1 and the second layer VLY2 may be stacked together, a slitting or slicing process may be performed on the stack to form the positive electrode active material layer 120, and then the positive electrode layer 120 and the positive electrode current collector 110 may be laminated, thereby forming the positive electrode layer 100.

Since the first layer VLY1 and the second layer VLY2 may be first formed through a dry process, and then bonded to each other through a pressing process, an interface between the first layer VLY1 and the second layers VLY2 may have a profile that is not flat. As an example, the interface between the first layer VLY1 and the second layer VLY2 may exist in the form of a region. As an example, the interface between the first layer VLY1 and the second layer VLY2 may include pores. As an example, the interface between the first layer VLY1 and the second layer VLY2 may include voids. As an example, the interface between the first layer VLY1 and the second layer VLY2 may be identified through, e.g., electron microscopy, component analysis, or the like.

As an example, since one surface of the positive electrode active material layer 120 in contact with the positive electrode current collector 110 may be formed through a slitting or slicing process, one surface of the first layer VLY1 and one surface of the second layer VLY2 in contact with the negative electrode current collector 110 may be substantially flat. As an example, since one surface of the positive electrode active material layer 120 in contact with the solid electrolyte layer 300 may be formed through a slitting or slicing process, one surface of the first layer VLY1 and one surface of the second layer VLY2 in contact with the solid electrolyte layer 300 may be substantially flat.

FIG. 2 is an enlarged view describing the positive electrode active material layer 120 according to examples of the present disclosure, and is an enlarged view of the region “M” in FIG. 1.

The positive electrode active material layer 120 according to examples of the present disclosure may include positive electrode active materials AM1 and AM2, solid electrolytes SE1 and SE2, a conductive material, and a binder. The positive electrode active materials AM1 and AM2 in the positive electrode active material layer 120 may provide a main path through which electrons are conducted. The solid electrolytes SE1 and SE2 in the positive electrode active material layer 120 may provide a main path through which lithium ions are conducted.

The total content of the positive electrode active materials AM1 and AM2 and the solid electrolytes SE1 and SE2 in the positive electrode active material layer 120 may be in a range of about 97 parts by weight to about 99.5 parts by weight relative to 100 parts by weight of the total of the positive electrode active materials AM1 and AM2, the solid electrolytes SE1 and SE2, the conductive material, and the binder.

The positive electrode active material layer 120 may include about 60 parts by weight to about 92 parts by weight of the positive electrode active material AM1 and AM2 relative to 100 parts by weight of the total of the positive electrode active materials AM1 and AM2, the solid electrolytes SE1 and SE2, the conductive material, and the binder.

The positive electrode active material layer 120 may include about 0.5 parts by weight to about 2 parts by weight of the binder based on 100 parts by weight of the total of the positive electrode active materials AM1 and AM2, the solid electrolytes SE1 and SE2, the conductive material, and the binder.

The positive electrode active material layer 120 may include about 0 parts by weight to about 2 parts by weight of the conductive material relative to 100 parts by weight of the total of the positive electrode active materials AM1 and AM2, the solid electrolytes SE1 and SE2, the conductive material, and the binder. For example, the positive electrode active material layer 120 may not include any conductive material.

In the positive electrode active material layer 120 according to examples of the present disclosure, the first layer VLY1 may include a first positive electrode active material AM1, a first solid electrolyte SE1, a conductive material, and a binder. The description of each of the first positive electrode active material AM1, the first solid electrolyte SE1, the conductive material, and the binder is the same as the description of the positive electrode active material, the solid electrolyte, the conductive material, or the binder of the positive electrode active material layer 120 described above with reference to FIG. 1.

The second layer VLY2 may include a second positive electrode active material AM2, a second solid electrolyte SE2, a conductive material, and a binder. The description of each of the second positive electrode active material AM2, the second solid electrolyte SE2, the conductive material, and the binder is the same as the description of the positive electrode active material, the solid electrolyte, the conductive material, or the binder of the positive electrode active material layer 120 described above with reference to FIG. 1.

The first positive active material AM1 may be the same as, or different from, the second positive active material AM2. The first solid electrolyte SE1 may be the same as, or different from, the second solid electrolyte SE2. The conductive material and the binder in the first layer VLY1 may be the same as, or different from, the conductive material and the binder in the second layer VLY2.

The first layer VLY1 may be or include a layer having a relatively high content of the positive electrode active material. The content of the first positive electrode active material AM1 in the first layer VLY1 may be greater than the content of the second positive electrode active material AM2 in the second layer VLY2. By including a relatively large amount of the first positive electrode active material AM1, the first positive electrode active material AM1 may be arranged or distributed consecutively in the thickness direction (the third direction D3) in the first layer VLY1. The movement path of electrons in the first layer VLY1 may be hardly disconnected, and may be formed in a relatively straight line. The first layer VLY1 may relatively provide a main path through which electrons are conducted.

The second layer VLY2 may be or include a layer having a relatively high content of a solid electrolyte. The content of the second solid electrolyte SE2 in the second layer VLY2 may be greater than the content of the first solid electrolyte SE1 in the first layer VLY1. By including a relatively large amount of the second solid electrolyte SE2, the second solid electrolytes SE2 may be arranged or distributed consecutively in the thickness direction (the third direction D3) in the second layer VLY2. The movement path of lithium ions in the second layer VLY2 may be hardly disconnected, and may be formed in a relatively straight line. The second layer VLY2 may relatively provide a main path through which lithium ions are conducted.

As an example, the weight ratio of the first positive electrode active material AM1 and the first solid electrolyte SE1 in the first layer VLY1 may be in a range of about 6:4 to about 9.5:0.5, about 8:2 to about 9.5:0.5, about 8.5:1.5 to about 9.5:0.5, or about 9:1. The weight ratio of the second positive electrode active material AM2 and the second solid electrolyte SE2 in the second layer VLY2 may be in a range of about 6:4 to about 9.5:0.5, about 6:4 to about 8:2, about 6.5:3.5 to about 7.5:2.5, or about 7:3.

Referring back to FIG. 1, the thickness TKP of the positive electrode active material layer 120 in the third direction D3 according to examples of the present disclosure may be in a range of about 40 μm or more. The positive electrode active material layer 120 according to the present disclosure may also be manufactured in the form of a thick film. For example, the thickness TKP of the positive electrode active material layer 120 in the third direction D3 may be in a range of about 40 μm or more, about 110 μm or more, or about 180 μm or more, and may be about 1 mm or less, about 500 μm or less, or about 300 μm or less.

The loading level of the positive electrode layer 100 may be in a range of about 20 mg/cm² or more. The positive electrode active material layer 120 according to examples of the present disclosure may also be manufactured in the form of a thick film. For example, the loading level of the positive electrode layer 100 may be in a range of about 20 mg/cm² or more, or about 25 mg/cm² or more, and may also be about 200 mg/cm² or less, or about 100 mg/cm² or less.

The positive electrode layer 100 and the unit cell (CEL) of the all-solid-state battery according to example embodiments of the present disclosure may have the following characteristics.

In the first layer VLY1 and the second layer VLY2 constituting the positive electrode active material layer 120 according to examples of the present disclosure, the movement path of electrons and the movement path of lithium ions may be hardly disconnected, and may be simplified. When the positive electrode active material layer 120 includes both the first layer VLY1, which provides a main path for electron conduction, and the second layer VLY2, which provides a main path for lithium-ion conduction, both the electron conductivity and the ion conductivity of the positive electrode layer 100 may be increased. The positive electrode active material layer 120 may reduce or prevent overvoltage of the positive electrode layer 100. When the positive electrode active material layer 120 includes the first layer VLY1 and the second layer VLY2, a region that may be substantially involved in the movement of electrons and/or lithium ions in the positive electrode active materials layer 120 may be increased. The positive electrode active material layer 120 may increase the reversible capacity of the positive electrode layer 100.

The positive electrode active material layer 120 according to examples of the present disclosure may have a thick film form. Even when the positive electrode active material layer 120 has the thick film form, the positive electrode layer 100 according to the present disclosure may have desired or improved electronic conductivity and ionic conductivity, may reduce or prevent overvoltage, and may have a relatively high reversible capacity.

The unit cell (CEL) of the all-solid-state battery according to examples of the present disclosure may have high capacity and high output characteristics by including the positive electrode active material layer 120 described above.

In the example embodiments to be described below, a detailed description of technical features overlapping those described above with reference to FIG. 1 and FIG. 2 is omitted, and differences is described in detail.

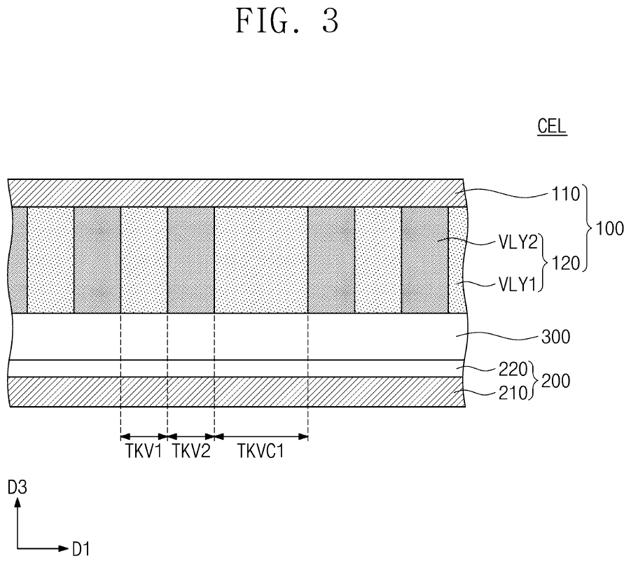

Referring to FIG. 3, in the positive electrode active material layer 120 according to examples of the present disclosure, the first layer VLY1 may include a plurality of first layers VLY1. Any one of the plurality of first layers VLY1 may have a width that is different from the width of each of, or the width of at least one of, the rest of the plurality of the first layers VLY1, respectively. As an example, the width TKVC1 of any one of the plurality of first layers VLY1 in the first direction D1 may be greater than the width TKV1 of each of the rest of the plurality of first layers VLY1. For example, the width TKVC1 may be in a range of about 1.2 times to about 2.5 times the width TKV1.

Any one of the plurality of first layers VLY1 may have a width that is different from the width of the second layer VLY2. For example, the width TKVC1 of any one of the plurality of first layers VLY1 in the first direction D1 may be greater than the width TKV2 of the second layer VLY2 in the first direction D1. For example, the width TKVC1 may be in a range of about 1.2 times to about 2.5 times the width TKV2.

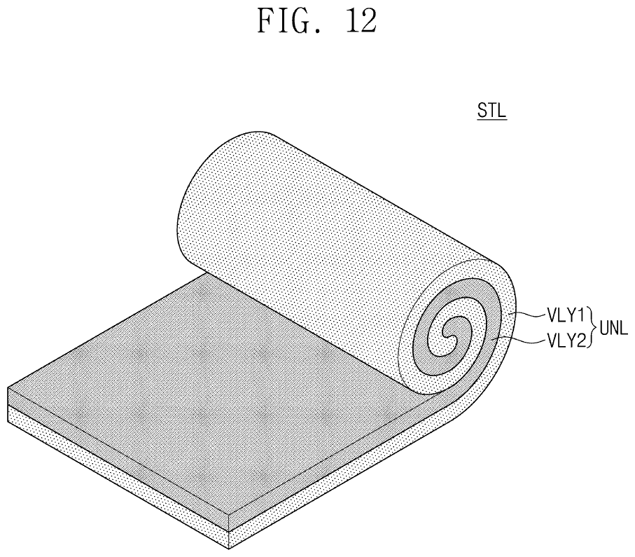

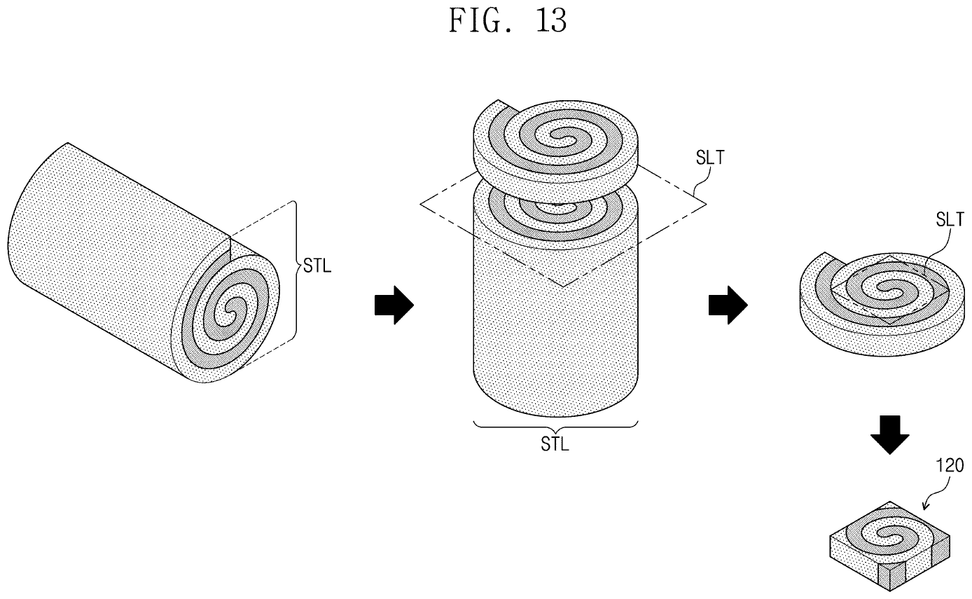

For example, examples of the present embodiment may be manufactured by a manufacturing method described below with reference to FIG. 12 and FIG. 13.

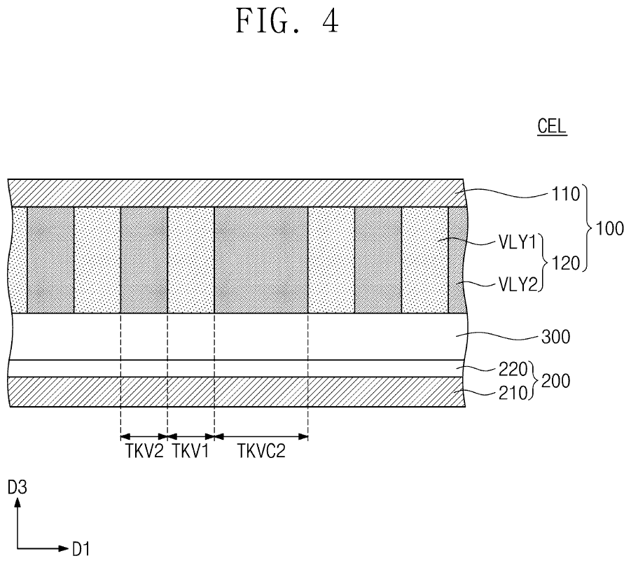

Referring to FIG. 4, in the positive electrode active material layer 120 according to examples of the present disclosure, the second layer VLY2 may include a plurality of second layers VLY2. Any one of the plurality of second layers VLY2 may have a width that is different from the width of each of, or the width of at least one of, the rest of the plurality of the second layers VLY2, respectively. For example, the width TKVC2 of any one of the plurality of second layers VLY2 in the first direction D1 may be greater than the width TKV2 of each of, or af at least one of, the rest of the plurality of the second layers VLY2 in the first direction D1. For example, the width TKVC2 may be in a range of about 1.2 times to about 2.5 times the width TKV2.

Any one of the plurality of second layers VLY2 may have a width that is different from the width of the first layers VLY1. As an example, the width TKVC2 of any one of the plurality of second layers VLY2 in the first direction D1 may be greater than the width TKV1 of the first layer VLY1 in the first direction D1. For example, the width TKVC2 may be in a range of about 1.2 times to about 2.5 times the width TKV1.

For example, examples of the present embodiment may be manufactured by a manufacturing method described below with reference to FIG. 12 and FIG. 13.

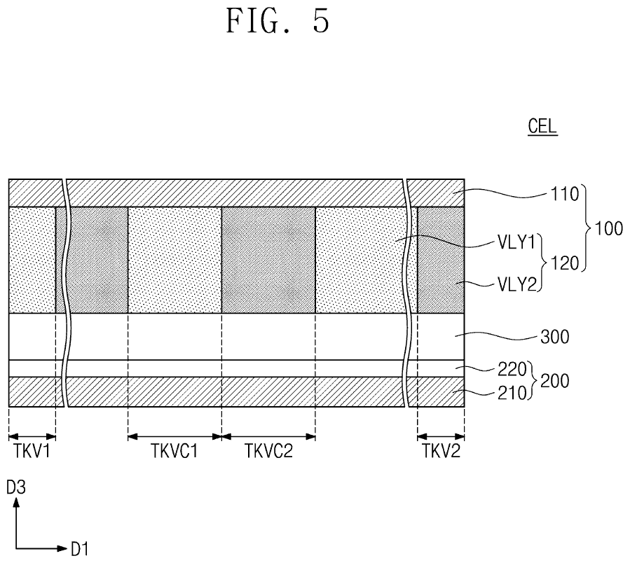

Referring to FIG. 5, in the positive electrode active material layer 120 according to examples of the present disclosure, the first layer VLY1 may include a plurality of first layers VLY1. Most of the plurality of first layers VLY1 may have a relatively large width TKVC1. The second layer VLY2 may include a plurality of second layers VLY2. Most of the plurality of second layers VLY2 may have a relatively large width TKVC2.

For example, any one of the plurality of first layers VLY1 may have a width that is different from each of, or from at least one of, the rest of the plurality of the first layers VLY1, respectively. For example, the width TKV1 of any one of the plurality of first layers VLY1 in the first direction D1 may be smaller than the width TKVC1 of each of the rest of the plurality of first layers VLY1 in the first direction D1. For example, the width TKVC1 may be in a range of about 1.2 times to about 2.5 times the width TKV1. Any one of the plurality of first layers VLY1 may be present at an end of the positive electrode active material layer 120.

For example, any one of the plurality of second layers VLY2 may have a width that is different from each of, or from at least one of, the rest of the plurality of the second layers VLY2, respectively. For example, the width TKV2 of any one of the plurality of second layers VLY2 in the first direction D1 may be smaller than the width TKVC2 of each of, or at least one of, the rest of the plurality of the second layers VLY2 in the first direction D1. For example, the width TKVC2 may be in a range of about 1.2 times to about 2.5 times the width TKV2. Any one of the plurality of second layers VLY2 may be present at an end of the positive electrode active material layer 120.

For example, the width TKVC1 of each of the rest of the plurality of first layers VLY1 may be substantially the same as the width TKVC2 of each of the rest of the plurality of second layers VLY2.

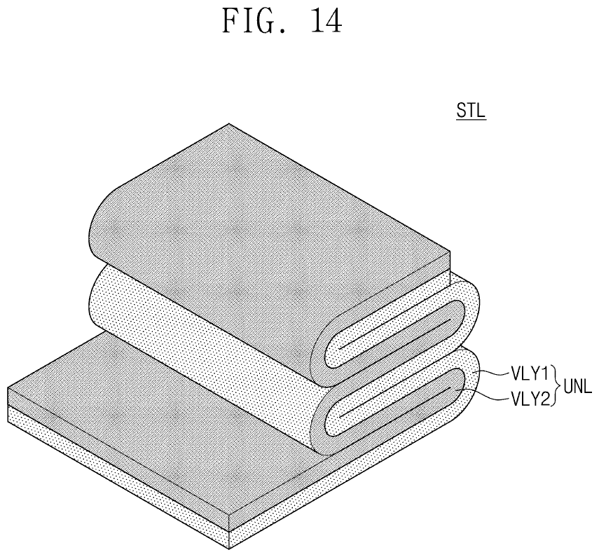

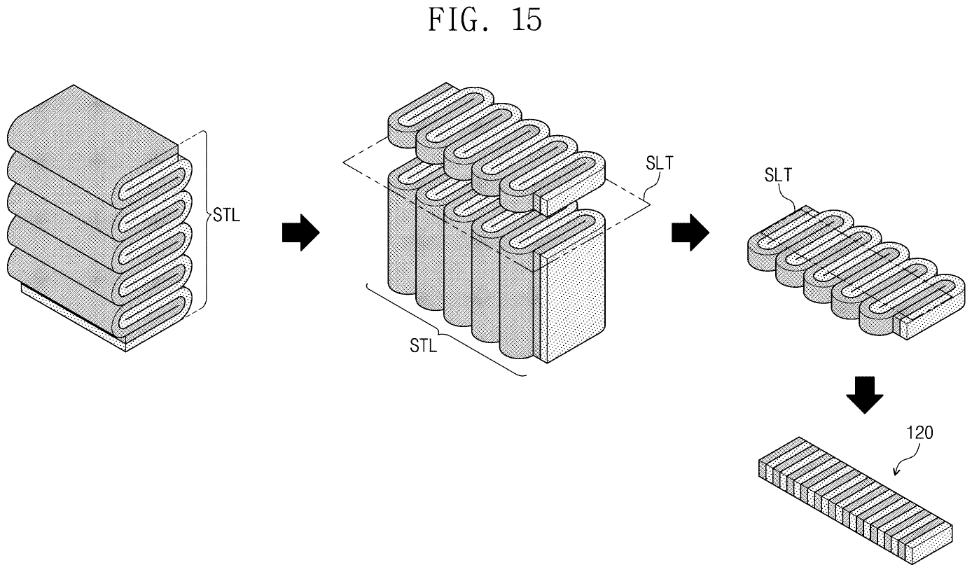

For example, examples of the present embodiment may be manufactured by a manufacturing method described below with reference to FIG. 14 and FIG. 15.

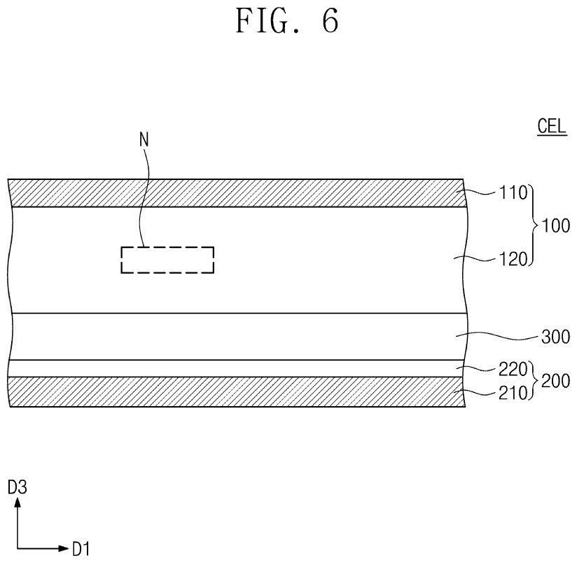

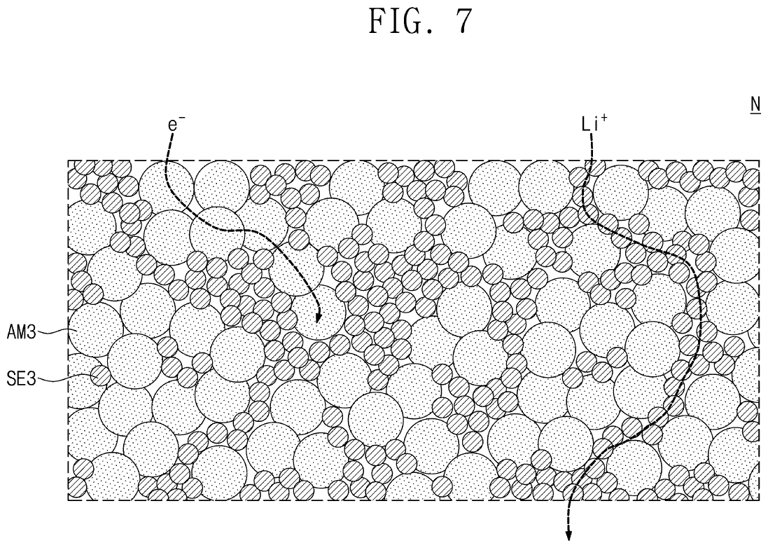

FIG. 6 is a cross-sectional view of a unit cell (CEL) of an all-solid-state battery according to a comparative example of the present disclosure. FIG. 7 is a figure describing a positive electrode layer 100 according to a comparative example of the present disclosure, and is an enlarged view of the region “N” in FIG. 6.

Referring to FIG. 6 and FIG. 7, the positive electrode active material layer 120 according to a comparative example of the present disclosure may include a third positive electrode active material AM3, a third solid electrolyte SE3, a conductive material, and a binder. The third positive electrode active material (AM3), the third solid electrolyte (SE3), the conductive material, and the binder are the same as the positive electrode active material, the solid electrolyte, the conductive material and the binder of the positive electrode active material layer 120 described above with reference to FIG. 1. The third positive electrode active material AM3 may be the same as or different from the first positive electrode active material AM1 and/or the second positive electrode active material AM2. The third solid electrolyte SE3 may be the same as or different from the first solid electrolyte SE1 and/or the second solid electrolyte SE2.

The weight ratio of the third positive electrode active material AM3 to the third solid electrolyte SE3 in the positive electrode active material layer 120 may be in a range of about 6:4 to about 9.5:0.5, about 6.5:3.5 to about 9:1, about 7:3 to about 9:1, about 7.5:2.5 to about 8.5:1.5, or about 8:2. The positive electrode active material layer 120 may be manufactured by mixing the third positive electrode active material AM3 and the third solid electrolyte SE3 at a specific weight ratio within the range of the weight ratio described above. That is, the positive electrode active material layer 120 according to the comparative example of the present disclosure may be or include one layer including the third positive electrode active material AM3 and the third solid electrolyte SE3 at a given weight ratio.

In the positive electrode active material layer 120 according to the comparative example of the present disclosure, the third positive electrode active material AM3 and the third solid electrolyte SE3 may be randomly or non-systematically distributed. In the positive electrode active material layer 120, the third positive electrode active material AM3 and the third solid electrolyte SE3 may be relatively irregularly distributed.

In the positive electrode active material layer 120 according to the comparative example of the present disclosure, the third positive electrode active material AM3 may not be arranged consecutively in the thickness direction (the third direction D3), and may be relatively irregularly distributed. Thus, the movement path of electrons in the positive electrode active material layer 120 may be interrupted, or may have a relatively complicatedly profile.

In the positive electrode active material layer 120 according to the comparative example of the present disclosure, the third solid electrolyte SE3 may not be arranged consecutively in the thickness direction (the third direction D3), and may be relatively irregularly distributed. Thus, the movement path of lithium ions in the positive electrode active material layer 120 may be interrupted, or may have a relatively complicatedly profile.

The positive electrode active material layer 120 according to the comparative example of the present disclosure may include a relatively large amount of inactive regions. That is, the positive electrode active material layer 120 may include a relatively large amount of regions that may not be substantially involved in the movement of electrons and/or lithium ions.

The positive electrode layer 100 according to the comparative example of the present disclosure may have relatively low electron conductivity and ionic conductivity. The positive electrode layer 100 according to the comparative example of the present disclosure may generate an overvoltage, or may have a relatively high irreversible capacity.

The positive electrode active material layer 120 according to the comparative example of the present disclosure may be a thick film. When the positive electrode active material layer 120 has a thick film form, the above-described problem may occur more severely.

Method for Manufacturing Positive Electrode for all-Solid-State Battery

FIG. 8 to FIG. 11 are perspective views describing a method for manufacturing a positive electrode for an all-solid-state battery, according to example embodiments of the present disclosure.

The method for manufacturing a positive electrode for an all-solid-state battery according to example embodiments of the present disclosure may include forming a unit active material layer including a first layer and a second layer through a dry process, forming a stack of the unit active material layers, performing a slicing process on the stack to form a positive active material layer, and laminating the positive active material layer on a positive current collector.

Referring to FIG. 8, a unit active material layer UNL including a first layer VLY1 and a second layer VLY2 may include a first layer VLY1, and a second layer VLY2 on the first layer VLY1. As described above with respect to FIG. 2, the first layer VLY1 may include the first positive electrode active material AM1 and the first solid electrolyte SE1. As described above, the second layer VLY2 may include the second positive electrode active material AM2 and the second solid electrolyte SE2.

The unit active material layer UNL may be formed through a dry process. Forming the unit active material layer UNL through the dry process may include forming the first layer VLY1 through the dry process, forming the second layer VLY2 through the dry process, and performing a pressing process on the first and second layers VLY1 and VLY2.

Forming the first layer VLY1 through the dry process may include dry-mixing the first positive electrode active material AM1, the first solid electrolyte SE1, the conductive material, and the binder to form a dry mixture and forming a film of the dry mixture.

Forming the second layer VLY2 through the dry process may include dry-mixing the second positive electrode active material AM2, the second solid electrolyte SE2, the conductive material, and the binder to form a dry mixture, and forming a film of the dry mixture.

Dry-mixing may refer to mixing in a state where a process solvent is not included. The process solvent may be or include, for example, a solvent used in the preparation of an electrode slurry. The process solvent may be or include, for example, water, N-Methylpyrrolidone (NMP), or the like, but is not limited thereto, and is not limited as long as the solvent is a process solvent used at the time of producing the electrode slurry.

Dry-mixing may be carried out with a mixer. The mixer may be, for example, a kneader. The mixer may include, for example, a chamber, one or more rotating shafts disposed within the chamber, and blades coupled to the rotating shafts so as to be rotatable, which are arranged in the length direction of the rotating shafts. The blades may be, for example, one or more of a ribbon blade, a sigma blade, a jet (Z) blade, a dispersion blade, and a screw blade. By including the blades, the positive electrode active material AM1 or AM2, the solid electrolyte SE1 or SE2, the conductive material, and the binder may be effectively mixed without a solvent. For example, a dough-like dry mixture may be prepared.

For example, the dry-mixing may be performed one or more times. First, the positive electrode active material AM1 or AM2, the solid electrolyte SE1 or SE2, the conductive material, and the binder may be first dry-mixed to prepare a mixture. The positive electrode active material AM1 or AM2, the solid electrolyte SE1 or SE2, the conductive material, and the binder may be substantially uniformly mixed by first dry-mixing. A fiberization process via kneading may then be performed. By performing a fiberization process via kneading, the binder (e.g., PTFE, and the like) may be fibrillated, and a dry mixture containing the binder may be obtained.

For example, a plasticizer or pore-forming agent may be added to the dry mixture to form pores inside the first layer VLY1 or the second layer VLY2.

The formed dry mixture may be filmed to form the first layer VLY1 or the second layer VLY2. For example, the dry mixture may be introduced into an extrusion device from a feeder and extruded in the form of a sheet or film. For example, the extrusion device may include a pair of rollers. The dry mixture may be introduced between a pair of rollers. As a result, the first layer VLY1 or the second layer VLY2 in the form of a film may be formed. For example, the first layer VLY1 or the second layer VLY2 may be or include a free-standing film.

The formed first layer VLY1 and second layer VLY2 may be stacked together, and a pressing process may be performed on the first layer VLY1 and the second layer VLY2, to form the unit active material layer UNL. For example, the pressing process may be performed using a pair of rollers. For example, the pressing process may be carried out using a pair of rollers heated to suitable temperature conditions. Through the pressing process, the first layer VLY1 and the second layer VLY2 may be bonded to each other. For example, the unit active material layer UNL may be or include a free-standing film.

The interface between the first layer VLY1 and the second layer VLY2 may have a profile that is not flat. For example, the interface between the first layer VLY1 and the second layer VLY2 may exist in the form of a region. For example, the interface between the first layer VLY1 and the second layer VLY2 may include pores. For example, the interface between the first layer VLY1 and the second layer VLY2 may be identified through electron microscopy, component analysis, or the like.

Next, a stack STL, in which the unit active material layers UNL are laminated, may be formed. In this step, the stack STL may be formed by sufficiently stacking the unit active material layers UNL so that the positive electrode active material layer 120 to be formed later may have a desired area.

Forming of the stack STL may include performing at least one of a stacking process, a winding process, or a folding process on the unit active material layer UNL.

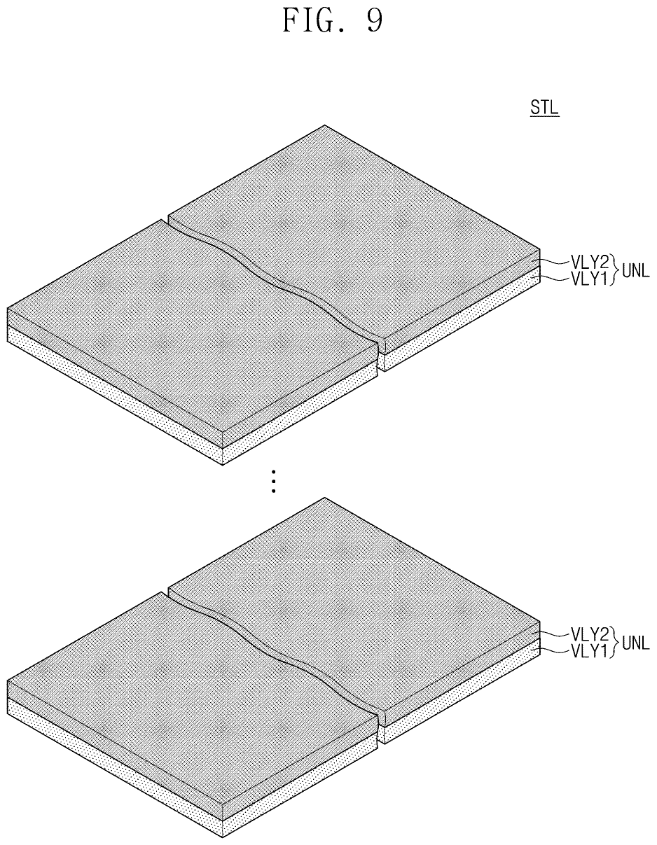

As an example embodiment of the present disclosure, referring to FIG. 9, a stacking process may be performed on the unit active material layer UNL to form a stack STL. In other words, the stack STL may be formed by stacking a plurality of unit active material layers UNL.

For example, a plurality of unit active material layers UNL may be stacked together, and a pressing process may be performed on the stacked plurality of unit active material layers UNL to form the stack STL. The pressing process may be a roll press, a flat plate press, or the like, but is not necessarily limited thereto. For example, the pressing process may be performed using a pair of rollers. For example, the pressing process may be carried out using a pair of rollers heated to suitable temperature conditions. Through the pressing process, the plurality of unit active material layers UNL may be bonded to each other.

The interface between the plurality of unit active material layers UNL may have a profile that is not flat. For example, the interface between the plurality of unit active material layers UNL may exist in the form of a region. For example, the interface between the plurality of unit active material layers UNL may include pores. For example, the interface between the plurality of unit active material layers UNL may be identified through electron microscopy, component analysis, or the like.

For example, the stack STL may be formed by stacking the plurality of unit active material layers UNL so that the first layers VLY1 and the second layers VLY2 may be alternately stacked.

Unlike as depicted, in another example, a stack STL may be formed by stacking a plurality of unit active material layers UNL so that the first layers VLY1 of two adjacent unit active material layers UNL face each other. Alternatively, the stack STL may be formed by stacking a plurality of unit active material layers UNL together so that the second layers VLY2 of two adjacent unit active material layers UNL face each other.

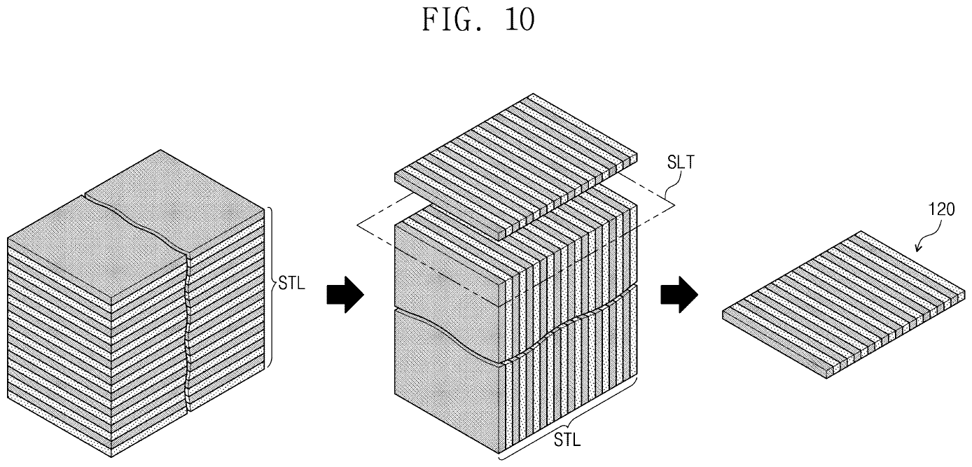

Referring to FIG. 10, a positive electrode active material layer 120 may be formed by performing a slitting or slicing process on the formed stack STL.

For example, the step may include standing the stack STL. That is, the positive electrode active material layer 120 may be formed by performing a slitting or slicing process on the standing stack STL. Standing may be rotating the stack STL in one direction so that a side surface of the formed stack STL becomes an upper surface.

The slitting or slicing process may be performed so that the positive electrode active material layer 120 may have a desired thickness or loading level. In this step, the positive electrode active material layer 120 having a thick film form may be formed.

For example, the slitting or slicing process may be performed multiple times on one stack STL. As a result, a plurality of positive electrode active material layers 120 may be formed.

Through the slitting or slicing process, the first layers VLY1 and the second layers VLY2 may be cut together. At least one surface of the cut first layer VLY1 and at least one surface of the cut second layer VLY2 may be flat. The at least one surface of the cut first layer VLY1 and the at least one surface of the cut second layer VLY2 may be coplanar.

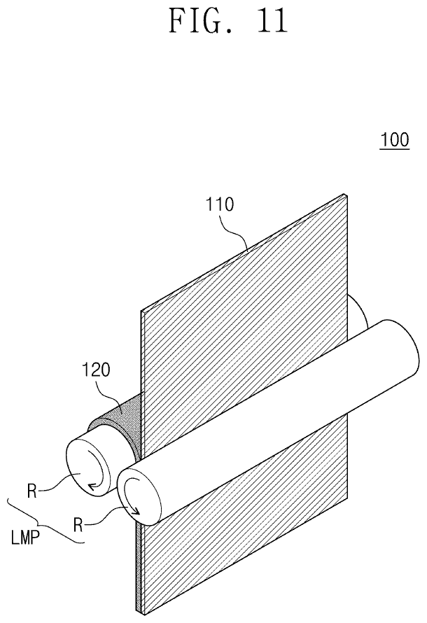

Referring to FIG. 11, the positive electrode active material layer 120 may be laminated to the positive electrode current collector 110.

The positive electrode active material layer 120 may be provided on one surface, or on both surfaces, of the positive electrode current collector 110 and laminated. The first layer VLY1 and the second layer VLY2 of the positive electrode active material layer 120 may be laminated to be in contact with the positive electrode current collector 110. The first layer VLY1 and the second layer VLY2 are disposed side-by-side on the positive electrode current collector 110. Lamination may be performed using lamination equipment or profile laminating machine (LMP) such as a roll press or a flat plate press, but is not necessarily limited thereto. For example, lamination may be performed using a pair of rollers R. For example, lamination may be performed using the pair of rollers R heated to a suitable temperature condition.

Unlike as depicted, the positive electrode current collector 110 may further include an adhesive layer on one surface, or on both surfaces.

In the example embodiments to be described below, a detailed description of technical features overlapping the technical features described above with reference to FIG. 8 to FIG. 11 is omitted, and differences are described in more detail.

Referring to FIG. 12 and FIG. 13, as another example of the present disclosure, by performing a winding process on the unit active material layer UNL, a stack STL in which the first and second layers VLY1 and VLY2 are stacked may be formed. Through a winding process, the first layer VLY1 and the second layer VLY2 may be wound together.

For example, a winding process may be performed on the unit active material layer UNL, and a pressing process may be performed to form the stack STL. The pressing step may be a roll press, a flat plate press, or the like, but is not necessarily limited thereto. For example, the pressing process may be performed using a pair of rollers. For example, the pressing process may be carried out using a pair of rollers heated to suitable temperature conditions. Through the pressing process, the first layer VLY1 and the second layer VLY2 in the unit active material layer UNL may be bonded to each other.

The interface between the first layer VLY1 and the second layer VLY2 may have a profile that is not flat. For example, the interface between the first layer VLY1 and the second layer VLY2 may exist in the form of a region. For example, the interface between the first layer VLY1 and the second layer VLY2 may include pores. For example, the interface between the first layer VLY1 and the second layer VLY2 may be identified through electron microscopy, component analysis, or the like.

A slitting or slicing process may be performed on the standing stack STL so that the positive electrode active material layer 120 may have a desired thickness or loading level. Additional slitting or slicing processes may be performed so that the positive electrode active material layer 120 may have a desired area.

For example, the unit active material layer UNL may be wound such that the second layer VLY2 may be on the inside thereof, and the first layer VLY1 may be exposed to the outside in the formed stack STL. Accordingly, the positive electrode active material layer 120 may be formed such that the second layer VLY2 may include a plurality of second layers VLY2, with the width TKVC2 of any one of the plurality of second layers VLY2 being greater than the width TKV2 of each of the rest of the plurality of the second layers VLY2 (see FIG. 4).

Unlike as depicted, as another example, the unit active material layer UNL may be wound such that the first layer VLY1 may be on the inside thereof, and the second layer VLY2 may be exposed to the outside in the formed stack STL. Accordingly, the positive electrode active material layer 120 may be formed such that the first layer VLY1 may include a plurality of first layers VLY1, with the width TKVC1 of any one of the plurality of first layers VLY1 being greater than the width TKV1 of each of the rest of the plurality of the first layers VLY1 (see FIG. 3).

Referring to FIG. 14 and FIG. 15, as another example of the present disclosure, by performing a folding process on the unit active material layer UNL, a stack STL in which the unit active material layers UNL are stacked may be formed. Through a folding process, the first layer VLY1 and the second layer VLY2 may be folded together.

For example, a folding process may be performed on the unit active material layer UNL, and a pressing process may be performed to form the stack STL. The pressing process may be a roll press, a flat plate press, or the like, but is not necessarily limited thereto. For example, the pressing process may be performed using a pair of rollers. For example, the pressing process may be carried out using a pair of rollers heated to suitable temperature conditions. Through the pressing process, the first layer VLY1 and the second layer VLY2 in the unit active material layer UNL may be bonded to each other.

The interface between the first layer VLY1 and the second layer VLY2 may have a profile that is not flat. For example, the interface between the first layer VLY1 and the second layer VLY2 may exist in the form of a region. For example, the interface between the first layer VLY1 and the second layer VLY2 may include pores. For example, the interface between the first layer VLY1 and the second layer VLY2 may be identified through electron microscopy, component analysis, or the like.

A slitting or slicing process may be performed on the standing stack (STL) so that the positive electrode active material layer 120 may have a desired thickness or loading level. Additional slitting or slicing processes may be performed so that the positive electrode active material layer 120 may have a desired area.

Accordingly, the positive electrode active material layer 120 may be formed such that the first layer VLY1 may include a plurality of first layers VLY1, and the second layer VLY2 may include a plurality of second layers VLY2, where the plurality of first layers VLY1 and the plurality of second layers VLY2 may have mostly relatively large widths (see TKVC1 and TKVC2 in FIG. 5).

For example, one first layer VLY1 present at the end of the positive electrode active material layer 120 among the plurality of first layers VLY1 may have a smaller width than the other first layers VLY1 among the plurality of the first layers VLY1. For example, the width TKV1 of any one of the plurality of first layers VLY1 may be smaller than the width TKVC1 of each of the rest of the plurality of the first layers VLY1 (see FIG. 5).

For example, one second layer VLY2 present at the end of the positive electrode active material layer 120 among the plurality of second layers VLY2 may have a smaller width than the other second layers VLY2 among the plurality of the second layers VLY2. For example, the width TKV2 of any one of the plurality of second layers VLY2 may be smaller than the width TKVC2 of each of the rest of the plurality of the second layers VLY2 (see FIG. 5).

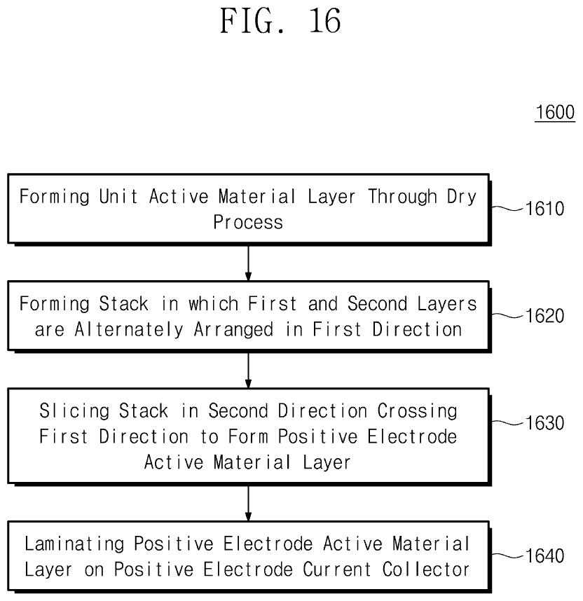

FIG. 16 is a flow chart illustrating a method for manufacturing a positive electrode for an all-solid-state battery, according to various example embodiments. In examples, the method 1600 include operation 1610 which includes forming a unit active material layer through a dry process, the unit active material layer including a first layer including a first positive electrode active material and a first solid electrolyte, and a second layer including a second positive electrode active material and a second solid electrolyte, the second layer being on the first layer. For example, a content of the first positive electrode active material in the first layer is greater than a content of the second positive electrode active material in the second layer, and a content of the second solid electrolyte in the second layer is greater than a content of the first solid electrolyte in the first layer.

Operation 1620 includes forming a stack in which the first and second layers are alternately arranged in a first direction. For example, forming of the stack includes performing at least one of a stacking process, a winding process, or a folding process on the unit active material layer.

Operation 1630 includes slicing the stack in a second direction crossing the first direction to form a positive electrode active material layer, the slicing of the stack including cutting the first and second layers together.

Operation 1640 includes laminating the positive electrode active material layer on a positive electrode current collector such that the first and second layers are in contact with the positive electrode current collector.

The method for manufacturing a positive electrode for an all-solid-state battery according to embodiments of the present disclosure may manufacture a positive electrode for the all solid-state battery in which both electron conductivity and ionic conductivity are improved. The method for manufacturing a positive electrode for an all-solid-state battery according to embodiments of the present disclosure may also manufacture a positive electrode for the all solid-state battery having the above-described characteristics in the form of a thick film.

The positive electrode for an all-solid-state battery according to embodiments of the present disclosure may have desired or improved electron conductivity and ion conductivity. In addition, the positive electrode for an all-solid-state battery according to embodiments of the present disclosure may reduce or prevent overvoltage and may have a relatively high reversible capacity.

An all-solid-state battery according to embodiments of the present disclosure may have high capacity and high output characteristics.

As described above, while the example embodiments of the present invention have been described with reference to the attached drawings, the present invention may be implemented in other specific forms without changing the technical idea or essential features thereof. Therefore, it should be understood that the example embodiments described above are illustrations in all respects and not limiting.

What is claimed is:

1. A method for manufacturing a positive electrode for an all-solid-state battery, the method comprising:
forming a unit active material layer through a dry process, the unit active material layer comprising a first layer including a first positive electrode active material and a first solid electrolyte, and a second layer including a second positive electrode active material and a second solid electrolyte, the second layer being on the first layer;
forming a stack in which the first and second layers are alternately arranged in a first direction;
slicing the stack in a second direction crossing the first direction to form a positive electrode active material layer, the slicing of the stack comprising cutting the first and second layers together; and
laminating the positive electrode active material layer on a positive electrode current collector such that the first and second layers are in contact with the positive electrode current collector.

2. The method as claimed in claim 1, wherein forming of the stack comprises performing at least one of a stacking process, a winding process, or a folding process on the unit active material layer.

3. The method as claimed in claim 1, wherein:
a content of the first positive electrode active material in the first layer is greater than a content of the second positive electrode active material in the second layer, and
a content of the second solid electrolyte in the second layer is greater than a content of the first solid electrolyte in the first layer.

4. A positive electrode for an all-solid-state battery, the positive electrode comprising:
a positive electrode current collector, and
a positive electrode active material layer on the positive electrode current collector,
wherein the positive electrode active material layer comprises:
a first layer including a first positive electrode active material and a first solid electrolyte;
a second layer including a second positive electrode active material and a second solid electrolyte, the second layer being in contact with the first layer, and
the first layer and the second layer are disposed side-by-side on the positive electrode current collector.

5. The positive electrode as claimed in claim 4, wherein:
a content of the first positive electrode active material in the first layer is greater than a content of the second positive electrode active material in the second layer, and
a content of the second solid electrolyte in the second layer is greater than a content of the first solid electrolyte in the first layer.

6. The positive electrode as claimed in claim 4, wherein:
a weight ratio of the first positive electrode active material to the first solid electrolyte in the first layer is in a range of about 8:2 to about 9.5:0.5, and
a weight ratio of the second positive electrode active material to the second solid electrolyte in the second layer is in a range of about 6:4 to about 8:2.

7. The positive electrode as claimed in claim 4, wherein:
the first layer comprises a plurality of first layers,
the second layer comprises a plurality of second layers, and
the plurality of first layers and the plurality of second layers are alternately disposed in a horizontal direction.

8. The positive electrode as claimed in claim 4, wherein a width of the first layer and a width of the second layer are substantially equal to each other.

9. The positive electrode as claimed in claim 4, wherein:
the first layer comprises a plurality of first layers, and
any one of the plurality of first layers has a different width than at least one other one of the plurality of the first layers.

10. The positive electrode as claimed in claim 4, wherein:
the second layer comprises a plurality of second layers, and
any one of the plurality of second layers has a different width than at least one other one of the plurality of the second layers.

11. The positive electrode as claimed in claim 4, wherein a loading level of the positive electrode is in a range of about 20 mg/cm² or more.

12. An all-solid-state battery, comprising:
a positive electrode layer, a negative electrode layer, and a solid electrolyte layer between the positive electrode layer and the negative electrode layer, wherein:
the positive electrode layer comprises a positive electrode current collector, and a positive electrode active material layer on the positive electrode current collector,
the positive electrode active material layer comprises:
a first layer including a first positive electrode active material and a first solid electrolyte; and
a second layer including a second positive electrode active material and a second solid electrolyte, the second layer being in contact with the first layer, and
the first layer and the second layer are disposed side-by-side on the positive electrode current collector.

13. The all-solid-state battery as claimed in claim 12, wherein the first layer and the second layer are in contact with the solid electrolyte layer.

14. The all-solid-state battery as claimed in claim 12, wherein:
a content of the first positive electrode active material in the first layer is greater than a content of the second positive electrode active material in the second layer, and
a content of the second solid electrolyte in the second layer is greater than a content of the first solid electrolyte in the first layer.

15. The all-solid-state battery as claimed in claim 12, wherein:
a weight ratio of the first positive electrode active material to the first solid electrolyte in the first layer is in a range of about 8:2 to about 9.5:0.5, and
a weight ratio of the second positive electrode active material to the second solid electrolyte in the second layer is in a range of about 6:4 to about 8:2.

16. The all-solid-state battery as claimed in claim 12, wherein:
the first layer comprises a plurality of first layers, and
the second layer comprises a plurality of second layers, and
the plurality of first layers and the plurality of second layers are alternately disposed in a horizontal direction.

17. The all-solid-state battery as claimed in claim 12, wherein a width of the first layer and a width of the second layer are substantially equal to each other.

18. The all-solid-state battery as claimed in claim 12, wherein:
the first layer comprises a plurality of first layers, and
any one of the plurality of first layers has a different width than at least one other one of the plurality of first layers.

19. The all-solid-state battery as claimed in claim 12, wherein:
the second layer comprises a plurality of second layers, and
any one of the plurality of second layers has a different width than at least one other one of the plurality of second layers.

20. The all-solid-state battery as claimed in claim 12, wherein a loading level of the positive electrode layer is in a range of about 20 mg/cm² or more.
